(19) United States
(12) Patent Application Publication
(10) Pub. No.: US 2006/0147075 A1
(43) Pub. Date: Jul. 6, 2006

(54) Loudspeaker comprising coaxially-disposed drivers

(75) Inventors: Vinh Thanh Vu, Colts Neck, NJ (US); William LeGall, Lansdale, PA (US)

Correspondence Address: DEMONT & BREYER, LLC, SUITE 250, 100 COMMONS WAY, HOLMDEL, NJ, 07733, US

(73) Assignee: Gingko Audio, Colts Neck, NJ (US)

(21) Appl. No.: 11/324,374

(22) Filed: Jan. 3, 2006

Related U.S. Application Data
(60) Provisional application No. 60/640,907, filed on Dec. 31, 2004.

(51) Int. Cl. H04R 1/02; H04R 25/00; H04R 9/06

(52) U.S. Cl. 381/335; 381/182; 381/332

(57) ABSTRACT

A loudspeaker incorporating a plurality of dynamic audio drivers in a co-axial arrangement is disclosed. In the illustrative embodiment, the drivers are disposed in a cylindrical cabinet has a diameter that is slightly larger than the diameter of the drivers. In some embodiments, a high-frequency driver is disposed on the exterior of the cabinet.

### STATEMENT OF RELATED CASES

This case claims priority of U.S. Provisional Patent Application 60/640,907, filed Dec. 31, 2004, which is incorporated by reference herein.

### FIELD OF THE INVENTION

The present invention relates generally to loudspeakers, such as for use in home audio systems.

### BACKGROUND OF THE INVENTION

The purpose of a home audio system is to reproduce a previously “recorded” musical performance. The recorded performance is preserved in any of a variety of different mediums, such as tape, LP, CD, SACD, DVD-A, etc. Of late, musical performances are even being preserved as digital files.

The home audio system typically includes a “source” component, the purpose of which is to extract from the recording medium a signal or waveform that is representative of the musical performance (hereinafter “the musical signal” or “the musical waveform”). The source component will be, for example, a cd-player, a tape player, a turntable for playing LPs, a digital music server, etc., consistent with the recording medium.

Control and amplification circuitry amplifies the musical waveform obtained from the source component, controls playback volume, and performs other functions. The control and amplification circuitry is typically found in a “receiver” or “integrated amplifier.” In some more ambitious audio systems, the control and amplification functionality is handled in two or more separate components, typically a “preamplifier” and “power amplifier.”

After being processed in the control and amplification circuitry, the musical waveform exists as an electrical signal. A transducer is required to convert this signal into a form that humans can hear as music. The transducer, which in the context of reproducing sound is referred to as a “loudspeaker,” performs this function by converting the electrical musical signal into a series of fluctuations in air pressure. These fluctuations create a pressure wave that our ears and brain interpret as “sound.”

The higher the pressure (i.e., the greater the amplitude) of these waves, the louder we perceive the sound. The faster the fluctuation (i.e., greater the frequency) of this wave, the higher the pitch. Variations in these and other parameters are a pressure-wave representation of the musical waveform, which we “hear” as the recreation of the musical performance.

The ability of an audio system to accurately recreate the sound of a musical performance from a recording thereof is dependent, in large part, on the quality of the loudspeakers. As a consequence, substantial attention has been directed to the continued development and refinement of loudspeakers.

As indicated above, the loudspeaker moves a mass of air in a way that a listener interprets as sound; specifically, the musical performance that is preserved by the recording medium. Given this basic operating principle, there are several approaches to loudspeaker design, as typified by the following types of loudspeakers:

1. Dynamic speakers;

2. Electrostatic speakers;

3. Planar-magnetic speakers; and

4. Horn-type speakers.

Dynamic loudspeakers are the most common and versatile of the various types of loudspeakers. Before discussing dynamic loudspeakers in some detail, a brief discussion of the other designs is presented.

The electrostatic loudspeaker typically uses a single “driver,” which consists of a relatively large, thin membrane that is stretched between two conductive stationary panels. The membrane is charged with an electrical current. Furthermore, the membrane receives the electrical musical signal—an alternating current—from the amplifier. The interaction of the musical signal and the electrical current causes the membrane to move, one way or the other, between the conductive panels. The movement of the membrane generates sound waves. Because the excursion or side-to-side movement of the membrane is quite small, electrostatic speakers must be very large if they are intended to reproduce low to very-low-frequency sound (e.g., the lowest pipe organ notes, etc.).

The planar-magnetic loudspeaker is similar in construction to the electrostatic loudspeaker. Like the electrostatic loudspeaker, the planar-magnetic design consists of a single driver, which is realized as a thin membrane that is disposed between two magnets. If the membrane is large, the “two” magnets are implemented as two large arrays of magnets. The membrane is conductive; either it is metallic or a conductive material (e.g., wire, etc.) is embedded in it. The electrical musical signal—an alternating current—is delivered to the membrane. As the current passes through the membrane, a magnetic field is generated that interacts with the magnetic fields of the surrounding permanent magnets. This causes the membrane to be either attracted to or repelled from the surrounding magnets. The movement of the membrane generates sound waves.

The horn loudspeaker uses traditional dynamic drivers, discussed below, that are placed at the small end of a waveguide. This combination—a driver and the attached waveguide—is typically called a “horn,” hence the classification of this type of speaker. Horn loudspeakers are typically more efficient than other types of loudspeakers and can generate high sound pressure levels (i.e., loud music) with relatively little power input.

The dynamic loudspeaker incorporates one or more dynamic audio “drivers.” FIG. 1 depicts an “exploded” side view of typical dynamic audio driver 100.

As depicted in FIG. 1, basket 112 (also called a “frame” or “chassis”) comprises relatively-larger diameter outer ring 114 and relatively-smaller diameter inner ring 116 that are interconnected by ribs 118. Basket 112 serves as a superstructure that supports the other elements of driver 100.

Cone 106 is a conical-shaped diaphragm. As described further below, cone 106 moves in response to the musical signal, which in turn moves air to produce sound. Typically, cone 106 is formed from paper, synthetics such as plastic, carbon-fiber-impregnated pulps, or metal(s).

Surround 108 serves as a compliant suspension for cone 106. Surround 108 is disposed at the periphery of cone 106 and couples it to outer ring 114 of basket 112. Surround 108 enables cone 106 to move and limits its movement (called “excursion”) in either direction beyond its rest position.

Voice coil 122 consists of a cylinder and a (typically) copper wire that is wound around the cylinder. The cylinder fits over pole or core 126 of cylindrical permanent magnet 128. The neck or small end of cone 106 is fixed to voice coil 122. The voice coil is held in place in central gap 130 of permanent magnet 128 by spider 110, which is a circular piece of pleated or ridged material (e.g., fabric, etc.). In addition to holding voice coil 122 in place, spider 110 also functions as a spring that returns the voice coil to its rest position. The voice coil and magnet assembly are often referred to as the “motor” of the driver. Other elements of driver 100 that are depicted in FIG. 1 include gasket 102, dust cap 104, electrical contacts 120, and back plate 132.

In operation, voice coil 122 receives the amplified electrical musical signal via wires 124. These wires are electrically connected to contacts 120 on basket 112. Other wires, not depicted, deliver the amplified musical signal to contacts 120. As previously noted, the amplified electrical musical signal is in the form of an alternating current. As this current moves through voice coil 122, it generates a magnetic field that varies as a function of the received electrical (musical) signal. The magnetic field that is generated by voice coil 122 interacts with the magnetic field that is generated by permanent magnet 128. This interaction causes voice coil 122 to move in response to variations in the magnetic field. Since cone 106 is physically coupled to voice coil 122, the cone moves in sync with the voice coil, creating waves of high and low air pressure.

Often, dynamic loudspeakers will include multiple dynamic drivers of the same or different size. The surface area of a driver's cone determines how much air can be moved, and, therefore, what frequencies the driver can reproduce. Most dynamic loudspeakers will, as a consequence, use several drivers of different sizes to reproduce the full range of musical frequencies. Generally, the smaller the driver, the higher the frequencies it can reproduce. The opposite is also true; the bigger the driver, the lower the frequencies it can reproduce. Table 1 below provides approximate driver size as a function of frequency reproduced:

TABLE 1
Approximate Driver Diameter as a Function of Frequency Range

| QUALITIVE | QUANTITATIVE | COMMON | APPROXIMATE |
|---|---|---|---|
| FREQUENCY | FREQUENCY | DRIVER | DRIVER |
| RANGE | RANGE <Hz> | NAME | DIAMETER <IN> |
| Very low | 20 to 100 | Subwoofer | 10+ |
| Low | 100 to 500 | Woofer | 8 to 10 |
| Mid | 500 to 6,000 | Midrange | 3.5 to 6.6 |
| High | 6,000 to 20,000 | Tweeter | 1 to 2 |

As an alternative to using a single large driver (for reproducing low frequencies), multiple smaller drivers can be electrically coupled to operate in unison. The combined surface area of the smaller drivers can duplicate that of a single larger driver to produce the same frequencies. In such alternative designs, the identical drivers are typically vertically arrayed in a co-planar arrangement.

To the extent that two or more drivers of different size are used in a dynamic loudspeaker, a frequency-divider network, typically called a “crossover,” must be used. The crossover segregates the original musical signal into an appropriate number of limited-frequency signals. In the case of a loudspeaker with two different-size drivers (i.e., a two-way loudspeaker), the crossover is used to direct relatively higher frequencies of the musical signal to the smaller driver and relatively lower frequencies to the larger driver. In the case of three-way loudspeakers (i.e., loudspeakers that have three-different size drivers), the musical signal must be trifurcated into three signals, and so forth. The intent is to as seamlessly as possible reproduce the complete ranges of frequencies handled by the particular loudspeaker.

The crossover is usually implemented as a separate module that is located within the loudspeaker cabinet or enclosure. The music signal from the amplifier is received by the crossover, segregated into an appropriate number of signals as a function of the loudspeaker design (e.g., two-way, three-way, etc.), and then the segregated signals are sent to the voice coil of the appropriate driver.

The cabinet that houses the drivers of a dynamic loudspeaker is an important aspect of the loudspeaker's design. Characteristics of the cabinet such as its size, shape, rigidity, and the presence or absence of ports or internal chambers have a major impact on the performance of a dynamic speaker.

Each of the various basic loudspeakers designs have certain characteristic strengths and weaknesses. And, even for a given type of loudspeaker (e.g., dynamic, etc.) many variations are possible, which ultimately influence the performance of the loudspeakers.

For example, regarding dynamic loudspeakers, in some designs, all drivers are forward firing (i.e., the drivers direct the sound toward the listener out of the “front” of the loudspeaker cabinet). In some other designs, some of the drivers are rear firing (i.e., sound is directed out of the back of the loudspeaker cabinet). In yet some other designs, some of the drivers are side-firing (i.e., sound is directed out of one or both of the sides of the loudspeaker cabinet).

Furthermore, some dynamic loudspeakers incorporate “time-aligned” drivers. Sound having a given frequency travels at a characteristic speed through air. In particular, the higher the frequency, the greater its speed. It is desirable for all frequencies to reach a listener at the same time. For this to occur, drivers that reproduce relatively higher frequencies must be set back further from the listener than drivers that reproduce relatively lower frequencies.

Variations in the shape of the cabinet and its rigidity affect the performance of a dynamic loudspeaker. In particular, internal reflections in the cabinet combined with the vibration of the cabinet itself can result in peaks or nulls in the frequency response of the loudspeaker (i.e., certain frequencies are emphasized or de-emphasized).

It will be appreciated that with the existing variety of choices as to operating principle, cabinet design, materials of construction, crossover design, etc., a virtually unlimited amount of loudspeaker designs are possible. Yet, loudspeakers are usually designed to a price point, which dictates the quality of individual components that are used to create the loudspeaker. As a general rule, the quality of those components affects the ability of the speakers to convincingly recreate the sound of musical instruments and a musical performance.

### SUMMARY OF THE INVENTION

The illustrative embodiment of the invention is a loudspeaker comprising at least a first, a second, and a third dynamic audio driver, wherein these three drivers face the same direction and are disposed in concentric relation with respect to one another. In the illustrative embodiment, the drivers are separated from one another by spacers. In some embodiments, a portion of a forward driver extends into the cone of the driver behind it.

Without being limited to any particular theory of operation, it is believed that the inventive arrangement of drivers results in a substantial increase in driver control. Specifically, in the inventive arrangement, one cone (i.e., the cone of the forward-most driver) is being driven, effectively, by three motors. Furthermore, the inventive arrangement is believed to result in reduced cone resonance since the cone of a forward driver is actively pressurized by the driver that is behind it.

Additionally, by virtue of this driver arrangement, relatively smaller and less expensive drivers will achieve sound pressure levels of a larger driver. It is generally advantageous to use smaller drivers since they avoid some of drawbacks that are inherent in the use of larger drivers. In particular, large drivers have large magnets, the mass of which generally results in slower driver response than a smaller driver having a smaller magnet.

As a result, the invention provides a loudspeaker that avoids some of the costs and disadvantages of prior-art designs. In particular, the loudspeaker exhibits performance characteristics that are unexpected in comparison to other loudspeaker designs that have a similar driver complement and parts quality. Among other characteristics, loudspeakers in accordance with the illustrative embodiment reproduce music with an unexpected degree of speed (e.g., transient response, etc.), dynamics, and low-frequency extension.

### BRIEF DESCRIPTION OF THE DRAWINGS

FIG. 1 depicts a prior-art dynamic audio driver.

FIG. 2A depicts a perspective view of loudspeaker 200 in accordance with the illustrative embodiment of the present invention.

FIG. 2B depicts a side view of loudspeaker 200 of FIG. 2A, including driver package 204.

FIG. 3 depicts an exploded side view of driver package 204.

FIG. 4 depicts a side view of driver package 204, as assembled.

FIG. 5 depicts the spatial relationship of the dynamic drivers within driver package 204 relative to one another.

FIG. 6 depicts further detail of driver package 204 within cabinet 202.

FIG. 7A depicts details of the electrical connection of the various drivers of loudspeaker 200 to a connector mounted on the exterior of a cabinet.

FIG. 7B depicts further detail of the connector of FIG. 7A.

FIG. 8A depicts a stand and crossover network for loudspeaker 200.

FIG. 8B depicts loudspeaker 200 receiving a digitally-processed signal, such as from a digital cross-over, room-correction software, or the like.

### DETAILED DESCRIPTION

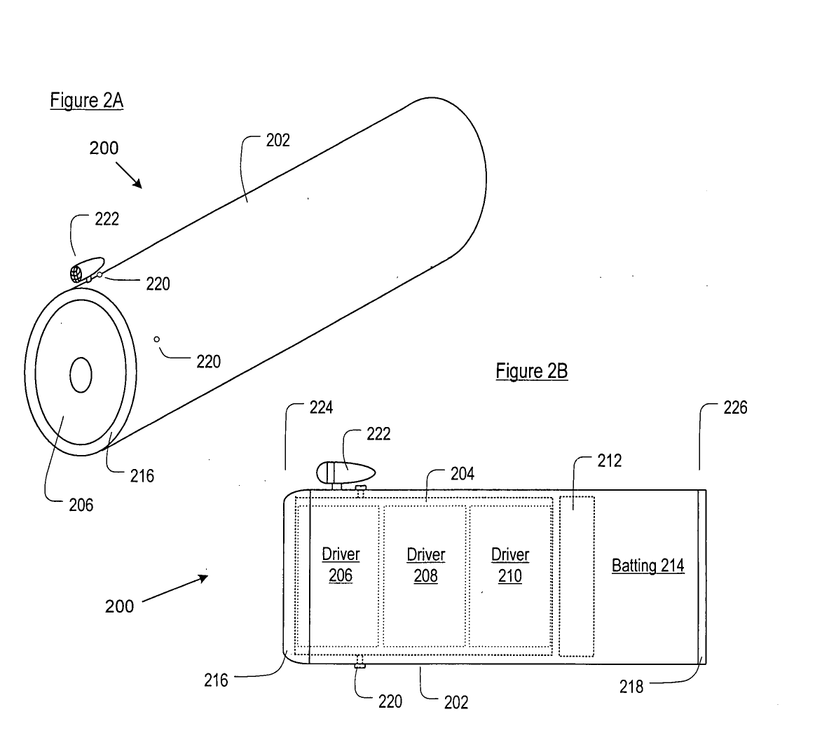

FIGS. 2A and 2B depict respective perspective and side views of loudspeaker 200 in accordance with the illustrative embodiment of the present invention. It is to be understood that, for two-channel listening, a second loudspeaker identical to loudspeaker 200 is required. For embodiments that involve the reproduction of more than two channels of audio, such as “home theater,” or “multi-channel audio,” three or more loudspeakers 200 are used.

With continued reference to FIGS. 2A and 2B, loudspeaker 200 includes cabinet 202, driver package 204, crossover network 212, batting 214, bezel 216, cap 218, and externally-mounted driver 222.

Cabinet 202 houses driver package 204. In the illustrative embodiment, cabinet 202 is tubular; that is; the cabinet has a cylindrical shape. Among any other benefits, the cylindrical shape of cabinet 202 tends to support fewer frequencies for standing waves than a rectangular-shape cabinet. In some other embodiments, cabinet 202 is not cylindrical, rather, it has a different shape, such as, without limitation, rectangular, or modifications of a rectangular shape, spherical, egg-shaped, etc.

Cabinet 202 is preferably rigid and inert. Suitable materials for cabinet 202 include, without limitation, glue-impregnated paper (i.e., paper board), hard plastic, wood, etc. While MDF (medium density fiberboard) is, in general, a preferred material for loudspeaker cabinets, it is poorly suited for use in embodiments in which cabinet 202 has a cylindrical shape. In embodiments in which cabinet 202 has a box-like shape, MDF is suitable for use.

In the embodiment that is depicted in FIGS. 2A and 2B, driver package 204 is disposed relatively closer to front end 224 of cabinet 202 than to its back end 226. As used herein, the phrase “front end” or “front,” when used to refer to cabinet 202, means the end of cabinet 202 that is nearest to the ideal listening position. That is, when a listener is situated in an ideal listening position, front end 224 of cabinet 202 faces the listener. Bezel 216 covers front end of cabinet 202. The bezel provides a finished look to the cabinet.

In the illustrative embodiment, driver package 204 includes three identical dynamic audio drivers 206, 208, and 210. As described in further detail later in this specification, the drivers in driver package 204 are arranged coaxially, one behind the previous driver. Driver package 204 is fixed in place within cabinet 202 via screws 220, which penetrate the exterior of cabinet 202.

Batting 214 is disposed in the open volume behind driver package 204. The purpose of batting is to decrease the incidence of standing waves within cabinet 202. Material that is suitable for use as batting includes, without limitation, polyester fill, wool, cotton, and the like.

In the illustrative embodiment, cabinet 202 is sealed. That is, the air within cabinet 202 does not escape (at any appreciable rate). In the illustrative embodiment, back end 226 of cabinet 202 is sealed via by cap 218. In some embodiments, cap 218 comprises several layers of resilient material. A resilient material such as rubber is used, as opposed to a rigid material, to decrease the incidence of standing waves in cabinet 202. In some other embodiments, resilient materials other than rubber can suitably be used. In some alternative embodiments, back end 226 of cabinet 202 is sealed using a passive radiator. In conjunction with this disclosure, those skilled in the art will know how to design and install a passive radiator for use in conjunction with the illustrative embodiment of the present invention.

In the illustrative embodiment, externally-mounted audio driver 222 is a high-frequency driver, such as a tweeter, super tweeter, etc., which is disposed on the exterior of cabinet 202. Externally-mounted audio driver 222 is disposed an appropriate distance rearward of leading dynamic audio driver 206 to provide time-alignment in well-known fashion. In the illustrative embodiment, audio driver 222 is a soft-dome bullet tweeter.

In the illustrative embodiment, loudspeaker 200 is a two-way system, wherein drivers 206 through 210 reproduce sounds in a first relatively lower range of frequencies and driver 222 reproduces sounds in a second relatively higher range of frequencies. As a consequence, loudspeaker 200 requires a crossover (see, Background section), such as crossover 212. For the purposes of illustration, crossover 212 is depicted as being situated within cabinet 202. In most embodiments, however, crossover 212 is not disposed within cabinet 202. The reasons for this, and further description concerning crossovers and electronic processing of the musical signal that is received by loudspeaker 200, is provided later in this specification.

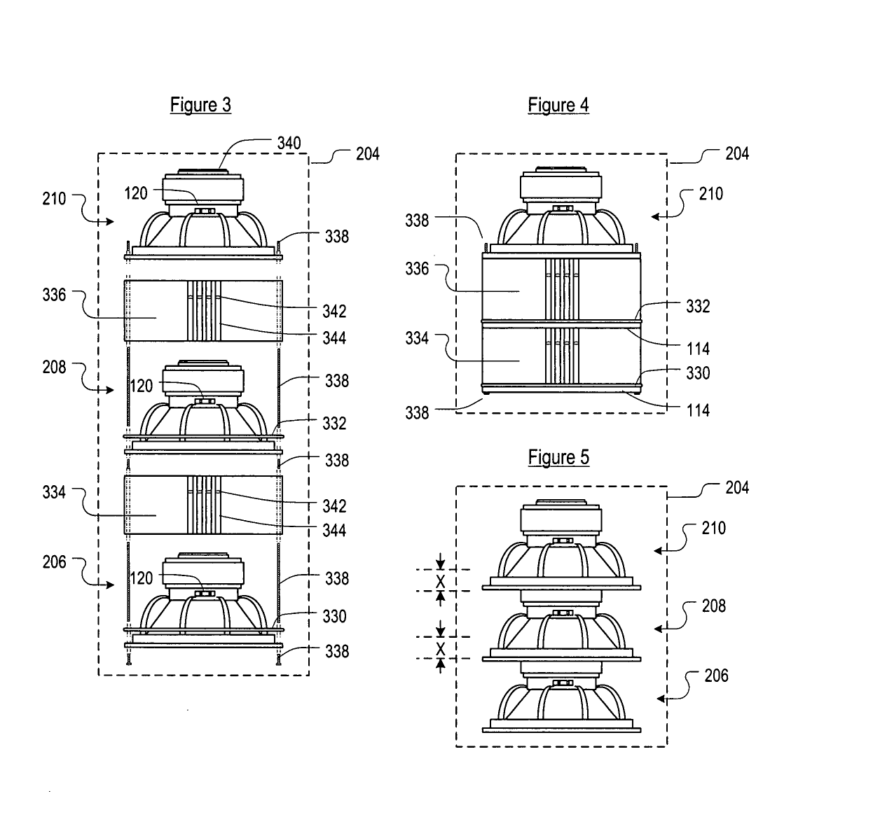

An illustrative embodiment of driver package 204 is now described in further detail with reference to FIGS. 3 through 5. FIG. 3 depicts an exploded side view of the salient elements of driver package 204, FIG. 4 depicts a side view of driver package 204, and FIG. 5 depicts the spatial relation of drivers 206 through 210 relative to one another within driver package 204.

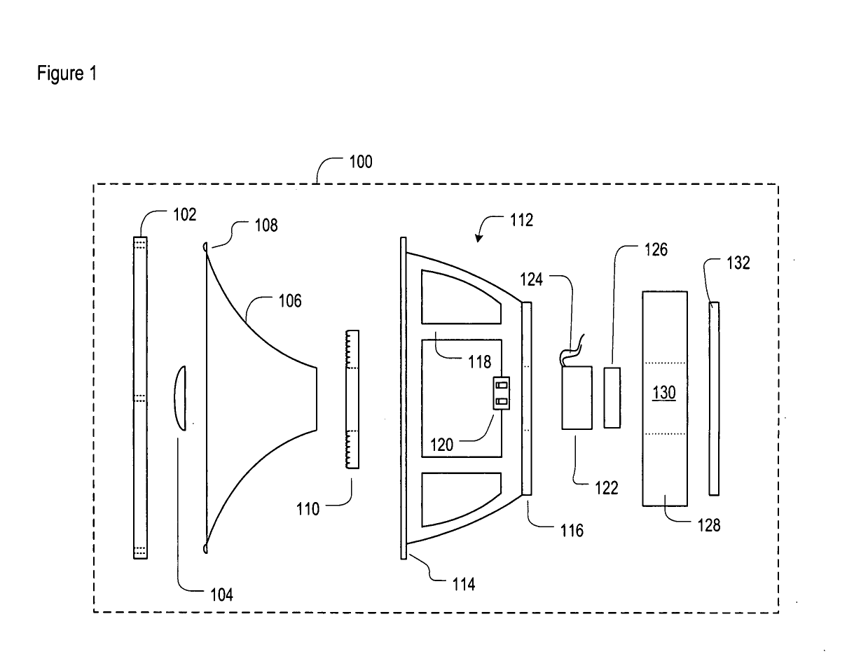

Drivers 206 through 210 are standard, prior-art dynamic audio drivers (i.e., configured in the manner of driver 100 of FIG. 1). In some embodiments, drivers 206 through 210 are mid-range drivers. In some additional embodiments, drivers 206 through 210 are woofers. In yet some further embodiments, drivers 206 through 210 are subwoofers. For consistency, the call-outs (reference numerals) that are used to identify the various elements of prior-art driver 100 in FIG. 1 will be assigned to like elements of drivers 206 through 210.

In FIGS. 3 through 5, driver package 204 is shown in a vertical orientation for clarity of illustration. It is to be understood that typically, although not necessarily, driver package 264 is disposed in a horizontal orientation within a loudspeaker cabinet, such as cabinet 202 (see, e.g., FIG. 2B), so that the drivers point in the general direction of a seated listener. In these figures, the lead driver; that is, the driver that is nearest to front end 224 of loudspeaker 200 (see, FIGS. 2A and 2B), is driver 206.

Referring now to FIGS. 3 and 4, in the illustrative embodiment, driver package 204 includes three drivers 206, 208, and 210, two gaskets 330 and 332, two spacers 334 and 336, and bolts 338.

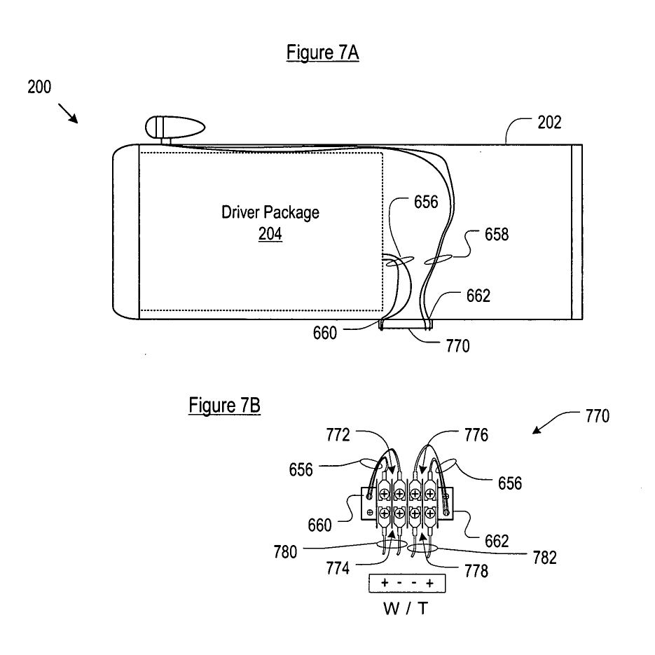

Spacer 334 is used, as its names implies, to “space apart” driver 208 from driver 206. Likewise, spacer 336 is used to space apart driver 210 from driver 208. The spacer should be made from a rigid material, such as materials that are suitable for use as enclosure 202. In some embodiments, both cabinet 202 and spacers 334/336 are made from glue-impregnated paper (i.e., paper board). Leads or wires (not depicted in FIGS. 3 through 5) by which drivers 206 and 208 receive a musical signal extend through holes 342 in spacers 334/336 and along ridges or channels 344 on the surface of spacers 334/336. Ultimately, these leads are electrically connected to an electrical connector (see, e.g., FIG. 7A, connector 770).

Gasket 330 is disposed on outer ring 114 of the basket of driver 206 to seal that driver against spacer 334. Similarly, gasket 332 is disposed on outer ring 114 of the basket of driver 208 to seal that driver against spacer 336. A gasket that is integral to each driver (see, e.g., gasket 102 of driver 100; FIG. 1) seals driver 208 against spacer 334 and driver 210 against spacer 336.

Bolts 338 tightly couple together the various drivers, gaskets, and spacers of driver package 204. For clarity, only two bolts 338 are depicted in FIGS. 3 and 4; typically, four bolts, situated at 90-degree intervals, are used to secure the elements of driver package 204. Screws 220 (see, e.g., FIGS. 2A and 2B) that penetrate cabinet 202 contact one of the spacers, such as spacer 334, to restrain driver package 204 from moving within cabinet 202.

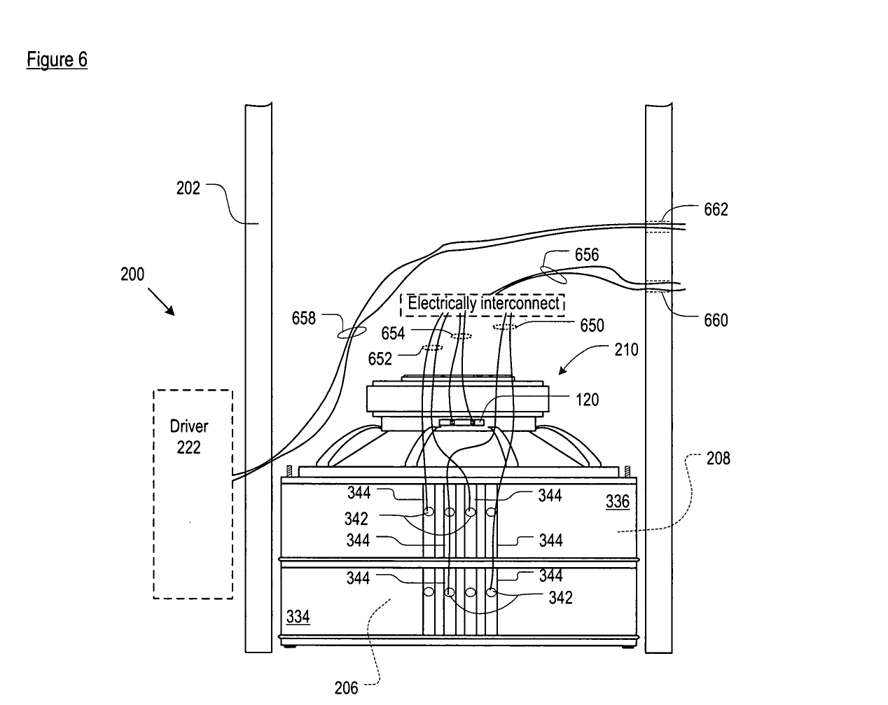

In the illustrative embodiment, the clearance between the inside of cabinet 202 and the outside of driver package 204 is very tight. In fact, in some embodiments, this clearance is less than 0.1 inches. This enables gaskets 330 and 332 to seal driver package 204 against the inside of cabinet 202, providing, as previously indicated, a sealed cabinet. Driver package 204 is advantageously wrapped in a material, such as conventional plastic wrap. The wrapping eases passage of driver package 204 into cabinet 202 in embodiments in which clearance is tight. Furthermore, the wrapping restricts leads or wires (see, e.g., FIG. 6) that traverse the outside of driver package 204 from moving about or snagging and breaking during insertion of the driver package into cabinet 202. It is notable that in some embodiments, cabinet 202 is molded and comprises several pieces that snap together. In such embodiments, the use of plastic wrap, etc., is not required since cabinet 202 is assembled around driver package 204.

As depicted in FIGS. 3 through 5, drivers 206 through 210 are arranged one behind another and are coaxial with respect to each other. Furthermore, in the illustrative embodiment, drivers 206 through 210 are coaxial with respect to cylindrically-shaped cabinet 202 in which driver package 204 resides.

In an embodiment that is depicted in FIG. 5, drivers 206 through 210 within driver package 204 are spaced apart from one another such that a portion of a more-forward driver is within the cone (i.e., the volume defined by the cone) of the driver behind it. More particularly, a portion of driver 206 extends into the cone of driver 208, and a portion of driver 208 extends into the cone of driver 210.

The extent (distance) x that the forward driver extends into the cone of the rearward driver is dependent, in part, on driver size. In particular, no part of the two drivers should touch each other. Ignoring driver movement, the larger the driver, the further (in terms of actual distance) the back of the forward driver can extend into the cone of the driver behind it. But larger drivers tend to have a larger excursion than smaller drivers. Sufficient clearance must be maintained so that at maximum excursion of the driver, the cone of a rearward driver does not contact the back plate of the driver in front of it.

As a rule of thumb, the more air space between the back of the forward driver and the dust cap of the rearward driver, the slower the speed of drivers. The reason for this is that a greater air space equates to a greater volume of air and, consequently, a greater mass that must be moved by the cone. Ultimately, distance x between the back plate (see, FIG. 1, back plate 132) of the more forward driver and the dust cap (see, FIG. 1, dust cap 104) of the more rearward driver is determined by empirical testing. That is, the distance x is varied, and for each value of x, the loudspeaker is evaluated with listening tests and, as desired, analytical testing (e.g., frequency response, etc.).

In some other embodiments, the back of the forward driver is essentially co-planar with the front of the driver behind it. In this embodiment, x=0, wherein a negative value for x would indicate a separation between the back of the forward driver and the front of the driver that is behind it (i.e., no overlap).

Due to the proximity of the cone of a driver to the back plate (see, e.g., back plate 132 of driver 100; FIG. 1) of the driver in front of it, the back plate of the drivers are covered with felt or other material to prevent the back plate from resonating.

FIG. 6 depicts further detail of driver package 204 within cabinet 202. To produce sound, drivers 206, 208, and 210 with driver package 204, and externally-mounted high-frequency driver 222 must, of course, be provided with a signal. In the illustrative embodiment, the musical signal is provided to these drivers via leads or wires, a part of which are depicted in FIG. 6.

As depicted in FIG. 6, wires 650, which are connected to the positive and negative leads of contact 120 (see FIG. 3) of driver 206, extend through two of holes 342 in spacer 334 and run along two corresponding channels 344, ultimately extending past rearmost driver 210. Similarly, wires 652, which are connected to the positive and negative leads of contact 120 (see FIG. 3) of driver 208, extend through two holes 342 in spacer 336 and run along channels 344, ultimately extending past rearmost driver 210. Leads 654 are likewise connected to contact 120 of rearmost driver 210.

Since the three drivers 206, 208, and 210 are intended to act in concert as a single driver, they are wired together. They can be wired in serial or parallel, but attention must paid to the effect that the wiring scheme will have on impedance. Typically, a parallel wiring scheme is used. In either case, the three pairs of leads 650, 652, and 654 are wired together such that a single pair of leads 656 exits the interior of cabinet 202 through hole 660. Leads 658 from externally-mounted driver 222 enter cabinet 202 and then exit through hole 662.

FIG. 7A depicts leads 656 from driver package 204 and leads 658 from driver 222 exiting cabinet 202 at its underside to connect to externally-mounted connector 770. FIG. 7B depicts a view of connector 770 from the underside of cabinet 202.

As depicted in FIG. 7B, leads 656 from driver package 204 emerge through hole 660 and are connected to the “driver-side” positive and negative “woofer” terminals 772 of connector 770. In the same fashion, leads 658 from externally-mounted driver 222 emerge through hole 662 and are connected to the driver-side positive and negative “tweeter” terminals 776 of connector 770. This particular arrangement is used for embodiments in which the musical signal has already been processed in a crossover such that the signal has been segregated for a two-way loudspeaker, as appropriate.

The other (“lower” as viewed in FIG. 7B) sets of terminals 774 and 778 of connector 770 provide electrical connection for respective leads 780 and 782, which provide the electrical musical signals to the drivers in driver package 204 and driver 222. Leads 780 and 782 conduct signals from the output of the crossover to connector 770, so that they can be relayed, via leads 656 and 658, to the drivers.

It is notable that at its location on the underside of cabinet 202, connector 770 will generally not be visible to a person that is listening to music via loudspeaker 200.

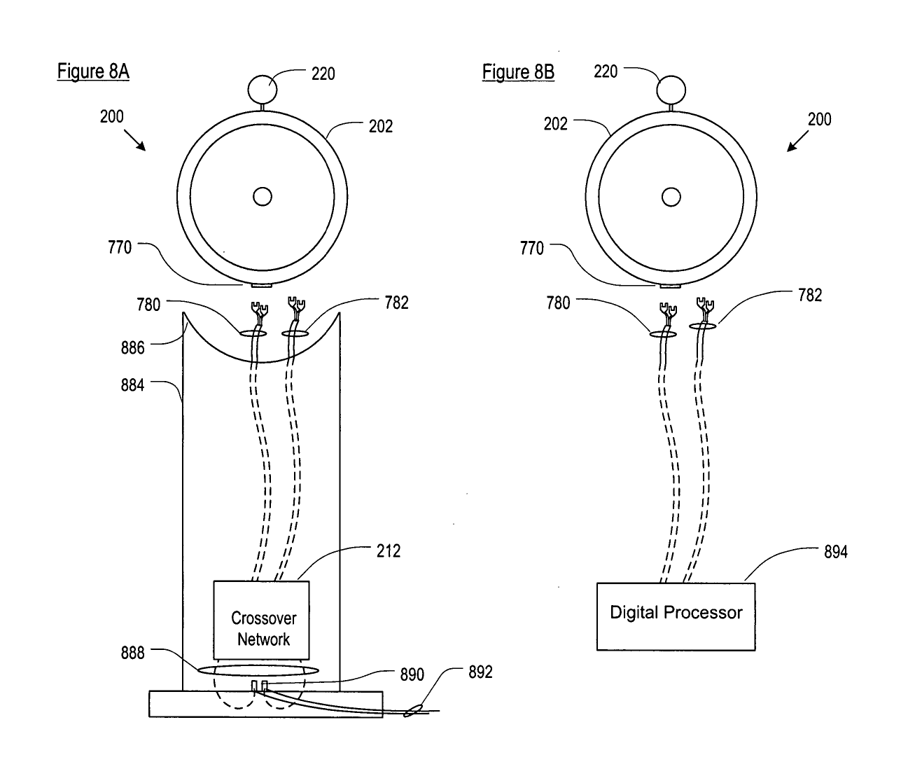

FIG. 8A depicts an embodiment of stand 884 for cabinet 202. In the embodiment that is depicted in FIG. 8A, crossover 212 is mounted internally within stand 884.

Leads 780 and 782 (see, also, FIG. 7B) originate from crossover 212, which is disposed near the base of stand 884. The leads extend beyond cradle portion 886, which is where cabinet 202 is received by stand 884. Leads 780 and 782 physically connect to connector 770 on the underside of cabinet 202 (see, e.g., Figure.

A second set of leads 888 place crossover network 212 in electrical contact with speaker terminals 890. Leads 892 from one channel of an amplifier (not depicted) conduct an amplified musical signal to speaker terminals 890.

FIG. 8B depicts an embodiment of loudspeaker 200 wherein a physical crossover (such as crossover 212 that incorporates resistor, capacitors, and inductors) is not used. Rather, the musical signal being carried on leads 780 (to driver package 204) and leads 782 (to externally-mounted driver 222) have been digitally processed in outboard digital processor 894. In this embodiment, loudspeaker 200 is assumed to be a two-way system. Consequently, the musical signal must be bifurcated into two frequency bands as previously described. In this embodiment, the segregation process is performed digitally in a digital crossover, which is not within cabinet 202 or within any stand (not depicted) that supports cabinet 202.

The ready accessibility of woofer and tweeter leads at externally-located connector 770 facilitates the use of an outboard digital crossover and/or other outboard digital processing, such as a digital room/speaker correction processor. Those skilled in the art, in view of this disclosure, will know how to make and use a digital crossover and/or digital room/speaker correction processor for use in conjunction with loudspeaker 200.

### EXAMPLE

A working model of loudspeaker 200 has been built. The enclosure (i.e., enclosure 202) has a cylindrical shape, with an 7.75 inch outside diameter, a 6.78 inch inside diameter, and a length of 17 inches. The enclosure is made of paper board that was formed into a tube. The paper board is commercially available from Sonoco of Hartsville, S.C., and others.

Driver package 204 includes three, 16-ohm, 6.5 inch dynamic drivers with paper cones. Drivers of this size are typically referred to as “mid-range” drivers. In the present example of a two-way system, such drivers are also properly referred to as “woofers.” The drivers in driver package 204 are wired in parallel for an overall impedance of about 5.5 ohms.

The drivers in package 204, at their maximum width, are 6.6 inches in diameter. The length of those drivers, from gasket to back plate, is about 3.4 inches. Spacers 334 and 336 have a length of 3.06 inches and an outside diameter of about 6.75 inches. The distance which a forward driver extend into the cone of the driver directly behind it is about 0.03 inches.

A 1 inch, soft-domed bullet tweeter is mounted on cabinet 202, functioning as externally-mounted driver 222.

Crossover 212 was implemented as a 2-way, 2nd order network using discrete components (e.g., capacitors, resistors, etc.) on a printed circuit board and an inductor coil located remotely from the printed circuit board. The crossover point is 4500 Hz and there is a 6 dB per octave slope above and below the crossover point.

Although in the illustrative embodiment of the present invention, driver package 204 includes three drivers, in some other embodiments, two drivers are used. And, in some further embodiments, driver package 204 contains more than three drivers.

In some embodiments, a passive drone membrane (not depicted) is disposed in front of lead driver 206. The drone membrane is driven by air that is being moved by driver 206 through 210. The drone membrane is light compared to driver 206 and is therefore able to accelerate and decelerate more rapidly than the drivers.

In some embodiments, a radiator (not depicted) is disposed in back of driver 210. The radiator can be passive or active and, in some embodiments, is wired out of phase to drivers 206 through 210. The out-of-phase current will cause the radiator to move in a direction that is opposite (or at least not in-sync) with drivers 206 through 210. This will effectively stiffen the compliance of the radiator. A potentiometer can be used to adjust the amount of signal current that is directed to the radiator, so that a user can adjust the bass dampening.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

We claim:

1. A loudspeaker comprising at least a first, a second, and a third dynamic audio driver, wherein said first, second, and third dynamic audio drivers face the same direction and are disposed in concentric relation with respect to one another.

2. The loudspeaker of claim 1 wherein a portion of said first dynamic audio driver extends into a cone of said second dynamic audio driver.

3. The loudspeaker of claim 1 wherein a first spacer is disposed between said first and second dynamic audio drivers and a second spacer is disposed between said second and third dynamic audio drivers.

4. A loudspeaker comprising a plurality of dynamic audio drivers, wherein:
(1) said dynamic audio drivers face the same direction;
(2) said dynamic audio drivers are disposed in concentric relation with respect to one another; and
(3) a portion of a first one of said dynamic audio drivers extends into a cone of a second one of said dynamic audio drivers, and wherein said first dynamic audio driver is disposed forward of said second dynamic audio driver relative to a listening position.

5. The loudspeaker of claim 4 wherein said dynamic audio drivers are the same size as one another.

6. The loudspeaker of claim 4 wherein there are exactly three of said dynamic audio drivers in said plurality thereof.

7. The loudspeaker of claim 4 wherein a portion of said second dynamic audio driver extends into a cone of a third one of said plurality of dynamic audio drivers, wherein said second dynamic audio driver is forward of said third dynamic audio driver.

8. The loudspeaker of claim 4 wherein a spacer is disposed between successive dynamic audio drivers in said plurality thereof.

9. The loudspeaker of claim 8 wherein each said spacer has a cylindrical shape.

10. The loudspeaker of claim 8 wherein a length of said spacer is less than a length of said dynamic audio drivers, as measured from a front gasket to a back plate of said drivers.

11. The loudspeaker of claim 4 wherein a material is disposed on a back plate of at least some of said dynamic audio drivers to prevent said back plate from resonating.

12. The loudspeaker of claim 8 wherein each said spacer and said plurality of dynamic audio drivers are physically coupled together defining a driver package.

13. The loudspeaker of claim 12 wherein said driver package is wrapped in a material that facilitates insertion of said driver package into a cabinet.

14. The loudspeaker of claim 4 further comprising a cabinet, wherein said plurality of dynamic audio drivers are disposed within said cabinet.

15. The loudspeaker of claim 14 wherein said cabinet has a cylindrical shape.

16. The loudspeaker of claim 14 further comprising a high-frequency driver, wherein said high-frequency driver is disposed outside of said cabinet, and further wherein said high-frequency driver is intended to reproduce relatively higher-frequency sound than said plurality of dynamic audio drivers that are disposed within said cabinet.

17. The loudspeaker of claim 16 further comprising a crossover, wherein said crossover is not disposed on or in said cabinet.

18. The loudspeaker of claim 14 wherein said cabinet is sealed.

19. The loudspeaker of claim 14 further comprising a stand, wherein said cabinet is movable relative to said stand, wherein said movement comprises rotation about a central, longitudinal axis of said cabinet.

20. A loudspeaker comprising a plurality of dynamic audio drivers, wherein:
(1) said dynamic audio drivers face the same direction;
(2) said dynamic audio drivers are disposed in concentric relation with respect to one another; and
(3) wherein a spacer is disposed between successive dynamic audio drivers in said plurality thereof.
